(19) United States
(12) Patent Application Publication
(10) Pub. No.: US 2024/0326392 A1
(43) Pub. Date: Oct. 3, 2024

(54) SHEETING AND METHODS OF MANUFACTURING SHEETING

(71) Applicant: UNIQCO-IP PTY LTD, Darling Point, New South Wales (AU)

(72) Inventor: Mark DELAFOSSE, Carrara (AU)

(73) Assignee: UNIQCO-IP PTY LTD, Darling Point, New South Wales (AU)

(21) Appl. No.: 18/579,467

(22) PCT Filed: Jul. 15, 2022
(86) PCT No.: PCT/AU2022/050752

§ 371 Date: Jan. 15, 2024

(30) Foreign Application Priority Data
Jul. 15, 2021 (AU) 2021902177
Jul. 15, 2021 (AU) 2021902178
Aug. 25, 2021 (AU) 2021221599
Aug. 25, 2021 (AU) 2021221600

(51) Int. Cl. B32B 27/08; B29C 48/00; B29C 48/08; B29K 23/00; B29K 105/26; B32B 3/12; B32B 3/28; B32B 5/18; B32B 27/06; B32B 27/18; B32B 27/32

(52) U.S. Cl. CPC B32B 27/08; B32B 3/12; B32B 3/28; B32B 5/18; B32B 27/065; B32B 27/18; B32B 27/32; B29C 48/0021; B29C 48/022; B29C 48/08; B29K 2023/0633; B29K 2105/26; B32B 2255/10; B32B 2255/205; B32B 2255/26; B32B 2264/104; B32B 2266/025; B32B 2266/08; B32B 2307/304; B32B 2307/518; B32B 2307/7246; B32B 2307/7376; B32B 2307/75; B32B 2439/62; B32B 2553/02

(57) ABSTRACT

A sheeting, including: an upper recyclable plastic layer; a lower recyclable plastic layer; a recyclable fluted plastic layer, interposed between the upper and lower layers; at least one of the upper or lower layers comprising: a printable BOPP sublayer; a base sublayer comprising a PE plastic, a bioplastic/compostable plastic, or a PP plastic; the fluted layer comprises a PE plastic, or a bioplastic/compostable plastic, a or PP plastic; the BOPP sublayer is layered to the base sublayer with an intermediate liquid laminating LDPE material; at least one of the upper or lower layers includes a metallised film sublayer, the metallised BOPP sublayer having a thickness between about 15 microns and about 50 microns; and the metallised upper or lower layer further includes a closed cell PE foam sublayer, layered to the metallised layer, the foam sublayer having a thickness between about 1 mm to 10 mm.

### RELATED APPLICATIONS

The present application claims priority to each of Australian provisional patent application no. 2021902178 entitled “Thermal Sheeting” filed on 15 Jul. 2021, Australian provisional patent application no. 2021902177 entitled “Packaging Printing System” filed on 15 Jul. 2021, Australian patent application no. 2021221599 entitled “Thermal Sheeting” filed on 25 Aug. 2021, and Australian patent application no. 2021221600 entitled “Packaging Printing System” filed on 25 Aug. 2021; and the entire contents of each of those applications is herein incorporated by reference.

The application also refers to and incorporates by reference the entirety of Australian patent application no. 2018333269 entitled “Fluted Sheeting” filed on 14 Sep. 2018, and International (PCT) application no. PCT/AU2021/050075 entitled “Packaging sheeting and a method of manufacturing packaging sheeting” filed on 1 Feb. 2021.

### FIELD OF THE INVENTION

The present invention relates to sheeting, and a sheeting layer, a method of manufacturing sheeting, and a method of manufacturing a sheeting layer. The present invention particularly relates to a printed fluted sheeting and a printed sheeting layer, and a method of manufacturing a printed fluted packaging sheeting and a printed sheeting layer, suitable to act as a thermal and moisture barrier.

The invention has been developed primarily for use in/with commercial food packaging for use in the transportation of food, and will be described hereinafter with reference to this application. However, it will be appreciated that the invention is not limited to this particular field of use.

### BACKGROUND OF THE INVENTION

The packaging industry over the past decades has included use of EPS, cardboard or plastic, and of ink printing directly onto a final packaging product.

Cardboard packaging may have a corrugated or fluted layer in between two outer flat planar layers connected at the tops of the corrugations therebetween. This can provide a useful and strong container. Although to some degree useful as a thermal insulation layer, cardboard packaging is prone to lose its structural integrity when exposed to moisture (e.g. due to liquid, or ice).

Plastic packaging is useful in providing a strong rigid container able to hold food, or other products, even when the food or product is packed in ice or otherwise exposed to moisture. However, the costs of this form of packaging can be very high, particularly when a closed container that seals is required, and when the container is required to be suitable for transportation and/or lightweight. Commonly, such containers are reasonably heavy open top containers and therefore not suitable for use in many food transportation contexts. A further problem of this type of packaging is that the open top allows for food to be tampered with, impacted or spoiled.

In order to provide a container that is lightweight yet thermally efficient, and closable, there has been a heavy reliance on waxed cardboard or polystyrene containers.

Waxed cardboard commonly comprises a corrugated or multi-layered cardboard that is wax impregnated using a wax coating system and PE wax. Waxed cardboard is only recyclable in a few very limited applications and is highly flammable. Waxed cardboard is primarily used to manage wet, humid or moist packaging conditions, to limit the impact that such conditions have on the structural integrity of the cardboard (e.g. to prevent it getting soggy).

PE lined cardboard boxes are regularly used by retailers. Retailers use this type of box to ship produce such as seafood, meat and poultry, and it is designed to be refrigerated or frozen.

Polystyrene is a petroleum-based plastic used in all kinds of products, from cups and trays to insulation and packaging. Most of the items made from polystyrene are designed to be for single use.

Expanded Poly Styrene (EPS) has excellent cushioning and thermal insulation properties and is therefore widely used to transport fresh produce, electronics and other goods. However, a key problem with EPS is that it is very difficult and/or costly to dispose of or recycle. It is bulky and non-biodegradable, which means it takes up a vast amount of space in landfills. It is also very light and readily breaks down into small pieces, and is therefore easily distributed across the environment.

While EPS is recyclable, it is generally uneconomic to collect and recycle because of the high volume-to-weight ratio, high costs of storage and transport and the low value of the recycled material. By way of example, approximately 22,000 tonnes of EPS packaging were placed onto the Australian market in 2017-18 (including approximately 12,000 tonnes of business-to-business (B2B) packaging) and only about 4,000 tonnes were recycled. This equates to a recycling rate of around 18%. Most recovery is from large end users such as fish and produce markets. The remainder—around 18,000 tonnes, amounting to a volume of about 360,000 m3—was sent to landfill. Around 240,000 m3 of this was B2B packaging including boxes.

It can be understood that there is a need to replace waxed cardboard and polystyrene as large amounts of these products are not being recycled, and they are difficult or not readily able to be recycled.

It can be seen that known prior art packaging, and the manufacture thereof, has the problems of, one or more of, or a combination of the following:
a) Difficulty in manufacturing lightweight, cost effective, and thermally insulating packaging;
b) Difficulty in the efficient manufacture of covered packaging;
c) Relying on the use of environmentally detrimental materials;
d) Difficulty in manufacturing environmentally friendly packaging in an instream processing;
e) Difficulty in manufacturing quickly enough to limit costs;
f) Difficulty in closing the loop to effectively recycle packaging material;
g) Printed packaging can have a rough or corrugated surface which, when printed onto directly, affects print quality;
h) Printing often fails (e.g. is distorted, smudged or lacks impact) on packaging used in moist, refrigerated or iced locations to keep food preserved;
i) How to effectively combine materials in a product providing effective thermal and moisture barriers, including by using resins and using other joining methods;
j) What printing material to use/what plastic sublayers to use/what adhesive to use/when to apply the adhesive and or any combination of these processes (e.g., at the printing stage or at the laminating stage), to produce a high print quality recyclable sheeting alternative to EPS and non-recyclable, or other less-recyclable packaging;
j) Lightweight packaging can be readily damaged in a printing press application; and/or
h) Blow on printing for large packaging results in imprecise imaging.

The present invention seeks to provide a sheeting, and a layer of sheeting, and a method of manufacturing sheeting and a layer of sheeting, which will overcome or substantially ameliorate at least some of the deficiencies of the prior art, or at least provide a useful alternative thereto.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, there is provided a fluted sheeting, including: an upper recyclable plastic layer; a lower recyclable plastic layer; a recyclable fluted plastic layer, interposed between the upper and lower recyclable plastic layers; at least one of the upper or lower recyclable plastic layers comprising: a printable BOPP sublayer; a base sublayer comprising a PE plastic, or a bioplastic/compostable plastic, a or PP plastic; and the fluted plastic layer comprises a PE plastic, or a bioplastic/compostable plastic, a or PP plastic; the printable BOPP sublayer is layered to the base sublayer with an intermediate liquid laminating LDPE material; at least one of the upper or lower recyclable plastic layers includes a metallised film sublayer, the metallised printable BOPP sublayer having a thickness between about 15 microns and about 50 microns; and the metallised upper or lower layer further includes a closed cell PE foam sublayer, layered to the metallised layer, the foam sublayer having a thickness between about 1 mm to 10 mm.

The metallised film layer may coat the HDPE sublayer. Such coating may be achieved using lamination, for example by LDPE or a similar bonding agent suitable for bonding the two materials.

The foam sublayer may be layered to the metallised film sublayer.

The base sublayer may comprise HDPE. The base sublayer may comprise HDPE and calcium carbonate. The base sublayer may comprise HDPE and a proportion of calcium carbonate ranging between about 50% and about 70% w/w of the base sublayer. The base sublayer may comprise HDPE and a proportion of calcium carbonate ranging between about 65% and about 70% w/w of the base sublayer.

The closed cell PE foam may have a thickness of between about 3 mm and about 5 mm.

The fluted plastic layer may comprise a PE plastic.

The sheeting may comprise a foldable blank for packaging sheeting. The foldable blank may be configured to be die cut. The foldable bank may be configured to form a box or other packaging with a closeable lid.

The sheeting is preferably washable and reusable.

The sheeting preferably provides an effective thermal and moisture barrier.

The metallised film layer may comprise aluminum foil. The fluted layer may comprise multiple regular or inherently irregular polygon-shaped recesses, or circular-shaped recesses, in a symmetrical repeat pattern. The recesses may be hexagonal in shape.

The fluted layer may comprise channels interconnected between the recesses.

A thermally insulating filler material may be included in the recesses and/or channels.

At least one edge of the sheeting is sealed.

The sheeting may include a further interposed sheet positioned between the upper layer and a further upper layer.

The sheeting may have a thickness in a range between about 1 mm and about 10 mm.

The sheeting may have a thickness in a range between about 1.5 mm and 4 mm.

The BOPP sublayer may be externally printed.

According to a further aspect of the invention, there is provided a method of manufacturing a recyclable fluted sheeting, the method comprising the steps of:
a. Layering a printable BOPP sublayer and a recyclable PE, PP or bioplastic base sublayer, and an intermediate liquid laminating LDPE material that is flowed between the sublayers
b. Forming an upper layer, or a lower layer, of the recyclable fluted sheeting by effecting a lamination and setting of the sublayers
c. Adding a metallised sublayer;
d. Forming a recyclable fluted layer;
e. Interposing the fluted layer between the upper layer and the lower layer; and
f. Fixing the interposed sheet to the upper layer and lower layer;
g. Adding a foam layer to the metallised layer, before or after fixing of the interposed sheet to the upper and lower layer;
   where the fluted plastic layer comprises a PE plastic, or a bioplastic/compostable plastic, or a PP plastic; at least one of the upper or lower recyclable plastic layers includes a metallised film sublayer, the metallised printable BOPP sublayer having a thickness between about 15 microns and about 50 microns; and the metallised upper or lower layer further includes a closed cell PE foam sublayer, layered to the metallised sublayer, the foam sublayer having a thickness between about 1 mm to 10 mm.

The metallised sublayer may be added to the BOPP sublayer before lamination with the base layer.

The foam layer may be added to the BOPP sublayer before fixing of the interposed sheet to the upper and lower layers.

The method may further comprise the step of forming one or more of the sublayers of the upper recyclable layer and the lower recyclable layers.

The forming of the one or more sublayers of the upper recyclable layer and the lower recyclable layer may comprise extruding a molten material. The forming of the fluted layer may comprise thermoforming. Alternatively, the fluted layer may be formed in any known manner

The LDPE may have a melting point of between about 110° C. and about 115° C. The LDPE processing temperature may be substantially between 150° C. and 210° C.

The BOPP sublayer and the base layer may be in rolls of sheets and fed into a laminating machine at a speed that matches the supply from the extruding with the speed of the laminating.

The base sublayer and the BOPP sublayer may be bonded by flowing a waterfall between the two sublayers using a resin cascade extruder. The speed may be between about 35 to about 120 metres per minute.

The BOPP layer may be fed at a comparative tension of a stretch rate of 1.06 relative to the base layer. The comparative tension may be provided by tensioning through the laminating machine and released by the cutting to packaging requirement size after lamination.

The method may include the step of vacuum coating the metallised film sublayer to the upper or lower layer.

The foam layer may be laminated to the upper or lower metallised layer using heat lamination.

The thermoformed fluted layer may comprise multiple regular or inherently irregular polygon-shaped recesses, or circular-shaped recesses, in a symmetrical repeat pattern, and the method further may comprise the step of including a filler material in the recesses and/or channels. The filling may be by waterfall or cascade filling. The fixing of the interposed sheet to the upper layer and lower layer may be by heat lamination.

The LDPE may be Linear LDPE (LLDPE).

The metallised film may be vacuum coated to the BOPP sublayer prior to LDPE lamination of the BOPP sublayer. Alternatively, the metallised film may be laminated using other bonding/adhesive or resin material to facilitate the bond/attachment/connection between a similar metalized or similar material and the BOPP or similar material.

The metallised film may comprise Aluminium. The metallised film may comprise a range of about 0.5% to 2% w/w of the metallised sublayer (e.g. the Al foil film comprises a range of about 0.5% to 2% w/w of the Al foil coated BOPP sublayer). The metallised film preferably comprises a less than about 1% w/w of the metallised sublayer.

The foam layer may be adhered to another layer or sublayer of the sheeting in using a variety of bonding or adhering means.

The closed cell polyethylene foam may be produced through extrusion or other means. The foam material can have a lamination process to the metalized film using a similar method to that previously described using the LDPE resin, or another liquid plastic resin, as the bonding agent. The metallised foam material can be laminated to an inside liner of the sheeting (e.g. by the closed cell PE being heat laminated or resin laminated to the inside liner, or the other side of the foam and metalized film being the metallised side is then laminated as previously described.

Layers, including the metallised foam layer, can then by corrugated together using heat to form an effective thermal insulating sheeting. The foam/metalized layer can have either side laminated, and remain recyclable.

The overall thickness off the fluted sheeting incorporating the closed cell foam may be in the range between about 2 mm and about 20 mm.

The thickness of the layer including the printed BOPP sublayer (or other printed sublayer, or film) and the base sublayer, which may include a metallised sublayer, is preferably between about 50 microns and about 1000 microns, or between about 100 microns and about 500 microns. The thickness of the printed layer including the metallised sublayer, but without any base sublayer, may have a thickness of between about 10 microns and 50 microns.

The sheeting may comprise rigid sheeting. The sheeting may comprise board sheeting. The sheeting may comprise crush-resistant sheeting.

The sheeting, or sheeting layer, may be configured to be foldable, to form a container. The container is preferably a box or other packaging with a closeable lid.

The sheeting, or sheeting layer, may be configured to be die-cut, or to be in an RSC format.

The lamination of sublayers and/or adhering or otherwise fixing of layers preferably occurs in an in-line manufacturing process.

The sheeting, or sheeting layer, may be washable, such that the surface is able be cleaned and reused, without damage to the printed surface. The sheeting is preferably waterproof and leak-proof

The sheeting may be configured to form a box. Preferably, the box is able to be machine erected (converted) by folding. Alternatively, or in addition, the box is able to be manually erected.

The sheeting may be configured to flat packing (e.g. to reduce storage and transportation costs).

The sheeting, or sheeting layer, preferably maintains structural integrity in cold-chain and refrigerated environments. Preferably, the integrity of the sheeting, or sheeting layer, lasts for many weeks or more (e.g. during long-range transport including sea-freight).

The sheeting, or sheeting layer, is preferably completely (100%) recyclable and/or completely (100%) reusable.

The sublayers (e.g. BOPP and/or HDPE) may be homogenous sublayers and/or directly joined (i.e. with no intervening sublayer(s)) using the liquid laminating material (e.g. LDPE).

According to a further aspect of the present invention, there is provided a method of manufacturing a recyclable fluted sheeting, the method comprising the steps of: a) forming an upper layer, or a lower layer, of the sheeting by laminating a first plastic sublayer and a plastic base sublayer, using an intermediate liquid laminating material that is flowed between the sublayers; b) adding a metallised film sublayer to the first sublayer or the base sublayer, either before or after lamination, or to the upper or lower laminated layer after lamination; c) forming a recyclable fluted layer; d) interposing the fluted layer between the upper layer and the lower layer; e) fixing the interposed sheet to the upper layer and lower layer; f) adding a foam layer, before or after fixing of the interposed sheet to the upper and lower layer.

The first sublayer may comprise a printable recyclable sublayer. The first sublayer preferably comprises BOPP. The base sublayer or fluted plastic layer may comprise a PE plastic, or a bioplastic/compostable plastic, or a PP plastic. The base sublayer is preferably HDPE. The metallised upper or lower layer may have a thickness between about 15 microns and about 50 microns.

The foam layer is preferably a closed cell foam layer, or sublayer, the foam sublayer having a thickness between about 1 mm to 10 mm. The foam layer may be adhered to the metallised upper or lower layer. The foam layer or sublayer may be laminated to the metallised film sublayer.

Heat may be applied to the laminating material to make it flowable between the sublayers. The heated laminated material, once it cools, may effect a setting of the liquid laminating material.

According to a further aspect of the present invention, there is provided a fluted sheeting, including: an upper recyclable plastic layer; a lower recyclable plastic layer; a recyclable fluted plastic layer, interposed between the upper and lower recyclable plastic layers; at least one of the upper or lower recyclable plastic layers comprising: a first sublayer and a base sublayer; and the first sublayer is layered to the base sublayer with an intermediate laminating material; at least one of the upper or lower recyclable plastic layers includes a metallised film sublayer.

The fluted sheeting may include a foam sublayer. The foam sublayer may have a thickness between about 1 mm to 10 mm.

The first sublayer may be printable. The first sublayer may be BOPP. Alternatively, it may be PP, CPP or BOPET, or Printed PE, TF-BOPE, or another recyclable printable sublayer.

The base sublayer and/or fluted layer may comprise a PE plastic, or a bioplastic/compostable plastic, or a PP plastic. The base layer is preferably HDPE.

The metallised upper or lower layer may have a thickness between about 10 microns and about 50 microns.

The foam may be closed cell PE foam. Alternatively, it the foam may be EPDM, neoprene or another recyclable foam.

The laminating material may be a liquid. It is preferably LDPE, or LLDPE. The foam sublayer may be laminated to the metallised film sublayer. It may alternatively be adhered or otherwise bonded to another sublayer, or to the upper or the lower layer (e.g. immediately before, or after, corrugation or fixing of the upper layer, fluted layer and lower layer).

According to a further aspect of the present invention, there is provided a recyclable plastic sheeting layer comprising: a printable sublayer; a base sublayer comprising a PE plastic, or a bioplastic/compostable plastic, a or PP plastic; the printable sublayer being layered to the base sublayer with an intermediate laminating material.

The intermediate laminating material is preferably liquid LDPE. The layering of the sublayers comprises flowing liquid LDPE as the intermediate laminating material.

The printable sublayer may comprise BOPP. Alternatively, it may be PP, CPP or BOPET, or Printed PE, TF-BOPE, or another recyclable printable sublayer.

The base sublayer may comprise a PE plastic, a bioplastic/compostable plastic, or a PP plastic. The base layer is preferably HDPE.

The printable sublayer, or the base sublayer, may include a metallised film sublayer, where the metallised printable sublayer has a thickness between about 15 microns and about 50 microns.

The plastic sheeting layer may further include a closed cell PE foam sublayer, layered to the metallised film (e.g. to the metallised base sublayer) or to a non-metallised base sublayer. The foam may be laminated the sheeting layer, or sublayer thereof, using a liquid LDPE laminating process as described herein with reference to the lamination of the base sublayer (e.g. HDPE) and printed sublayer (e.g. BOPP).

The foam sublayer may have a thickness between about 1 mm to 10 mm.

A method of forming a recyclable sheeting layer, the method comprising the steps of: a) forming a printable sublayer; b) forming a base sublayer of the sheeting layer comprising recyclable a PE plastic, a PP plastic or a bioplastic; c) laminating the printable sublayer and the base layer, using a heated intermediate liquid laminating material that is flowed between the sublayers, the heat used to effect a lamination and setting of the liquid laminating material;

The method may further comprise the step of adding a metallised film sublayer to the printable layer to form a metallised printable sublayer, wherein the metallised printable sublayer has a thickness between about 15 microns and about 50 microns.

The method may further comprise adding a foam sublayer to the laminated sheeting layer. The foam may be laminated the sheeting layer, or sublayer thereof, using a liquid LDPE laminating process. The foam sublayer may comprise a closed cell PE foam sublayer, layered to the metallised sublayer, the foam sublayer having a thickness between about 1 mm to 10 mm. The foam preferably has a thickness between about 2 mm and about 5 mm.

The intermediate laminating material is preferably liquid LDPE.

The forming of one or more of the sublayers or layers may comprise extruding a molten material.

The plastic sheeting layer may be configured to form an upper and/or lower layer, or wall, of a recyclable fluted sheeting.

The recyclable printed sublayer may be an OPP sublayer, such as a BOPP sublayer.

The sheeting layer may be washable and reusable. The sheeting layer may provide an effective thermal and moisture barrier. The sheeting layer may have a thickness in a range between about 0.05 mm and about 1 mm.

According to a further aspect of the invention, there is provided a method of manufacturing sheeting, the method comprising the steps of: i) forming an upper outside wall and a lower outside wall; ii) forming multiple recesses and/or channels in a symmetrical repeat pattern on a sheet of material to form a formed sheet; iii) interposing the formed sheet between the upper outside wall and the lower outside wall; iv) fixing the formed sheet to the upper outside wall and the lower outside wall.

The method may include the step of extruding a molten material to form the upper outside wall and the lower outside wall.

The method may include the step of filling or partially filling the recesses and/or channels on the formed sheet with a further material. The step of filling or partially filling the recesses and/or channels may be by cascade filling or waterfall filling on said recesses and/or channels.

The further material may provide improved strength, resilience, resistance and/or thermal properties of the sheeting.

The filling or partial filling of the recesses and/or channels on the formed sheet may be effected before, or during, fixing of the upper and lower outside walls to the formed sheet.

The filling or partial filling of the recesses and/or channels on the formed sheet may be effected from above the formed sheet on those recesses and/or channels on the formed sheet before fixing of the upper and lower outside walls to the formed sheet.

According to a further aspect of the invention, there is provided a sheeting comprising: an upper outside wall and a lower outside wall; and a formed sheet interposed and fixed between the upper outside wall and the lower outside wall, the formed sheet including multiple recesses and/or channels in a symmetrical repeat pattern.

The upper outside wall and the lower outside wall may be, or the formed sheet may be, manufactured from a material which includes a polymeric material.

The recesses and/or channels on the formed sheet may be at least partially filled with a further material providing improved strength, resilience, resistance and/or thermal properties of the sheeting.

The further material may be filled by cascade filling or waterfall filling on the recesses and/or channels.

The sheeting may include at least a second formed sheet fixed between a first formed sheet and the upper outside wall or the lower outside wall. The first formed sheet and the second formed sheet may be fixed to an intermediate wall between the first formed sheet and the second formed sheet.

According to a further aspect of the present invention, there is provided a method of forming a recyclable printed sheeting layer, the method comprising the steps of: a) Forming a recyclable base sublayer; b) Forming a sublayer of printed recyclable plastic; c) Layering the base sublayer to the printed sublayer with an intermediate liquid laminating material; and d) Joining the sublayers by heating and flowing the liquid laminating material between the sublayers to effect a lamination of the base sublayer and the printed sublayer.

Preferably, the printed sheeting layer is for a recyclable nonporous container.

According to a particularly preferred form of the present invention, the recyclable base layer is a composite high density polyethylene (HDPE) and calcium carbonate.

According to a further aspect of the invention, there is provided a method of forming recyclable printed sheeting layer, the method comprising the steps of: a) forming a recyclable base sublayer comprised of high density polyethylene (HDPE) and calcium carbonate; b) forming a sublayer of externally printed recyclable plastic comprised of Biaxially Oriented Polypropylene (BOPP); c) layering the base sublayer to the printed sublayer with an intermediate liquid laminating material of a Low Density Polyethylene (LDPE) or similar resin; d) feeding a sheet of the base sublayer from a corresponding roll together with a sheet of the externally printed BOPP sublayer from a corresponding roll; e) using the intermediate liquid laminating material of the LDPE resin as the bonding agent between the two sublayers by flowing the liquid laminating material between the sublayers; f) heat effects setting of the liquid laminating material wherein there is effected a lamination of the base sublayer and the sprinted BOPP layer.

Preferably, the recyclable sheeting layer is for use a recyclable thermal container.

Preferably, the packaging can be assembled to achieve any one or more of the following: i. improvements in printing quality ii. a sheeting layer able to be used in moist environments such as in refrigeration or with ice packing iii. a manufacturing process that does not diminish the quality of print and smoothness of the sheeting layer iv. a sheeting layer that is suitable for folding and converting (i.e. knocking down) v. a sheeting layer that is able to be washed and sanitized, and be reused multiple times following washing and sanitizing.

According to a further aspect of the present invention, there is provided a method of forming a packaging lamination for use as a recyclable thermal container, the method comprising the steps of: a) forming a recyclable base sublayer; b) forming a further sublayer of recyclable plastic; c) layering the sublayers with an intermediate liquid laminating material; d) joining the sublayers by applying heat to the liquid laminating material and flowing it between the layers, and effecting setting of the liquid laminating material and a lamination of the sublayers.

Preferably, the further sublayer is printable.

In another aspect, there is provided a packaging sheeting, the sheeting comprising: an upper outer wall (also referred to as an upper layer) and a lower outer wall (also referred to as a lower layer); and an interposed sheet (also referred to as a layer) between the outer walls, the interposed sheet including multiple either regular or inherently irregular polygon-shaped recesses in a symmetrical repeat pattern, or conventional fluting having a wave profile.

The recesses or flutes may be separated from each other on an upper side by interconnected channels.

The recesses may be tessellated. The recesses and channels may be formed on the sheet in a tessellated pattern. The tessellated pattern on the formed sheet may be surrounded by a flat or non-patterned portion of the sheet.

The recesses may be hexagon-shaped.

Preferably, at least one of the outer walls comprises the recyclable laminated sheeting layer described in other aspects of the invention. Preferably, the recyclable laminated sheeting layer comprises a printable BOPP sublayer, and an HDPE base sublayer, laminated together by flowing a liquid LDPE between the sublayers.

The upper outer wall, lower outer wall and interposed sheet may comprise a plastic material. The plastic may be any plastic or combination of recyclable plastics and/or recyclable plastics with additives, including: polyethylene (e.g. HDPE, or MDPE) and calcium carbonate; LDPE, including LLDPE; bioplastic (e.g. produced from corn starch; or plants); polypropylene (PP); polypropylene and calcium carbonate; polypropylene and magnesium silicate; polypropylene and Talcum Powder and/or carboxymethyl cellulose (CMC).

The plastics material can be a composite material. The composite material can be polyethylene (comprising about 30% to about 50% w/w of the composite material, and more preferably about 30% to about 35% w/w of the composite material) combined with calcium carbonate (comprising about 50% to about 70% w/w of the composite material, and more preferably, about 65% to about 70% of the composite material). Recycled polyethylene can also be included. The percentages of polyethylene, calcium carbonate or talcum, and recycled polyethylene can depend on the application of the sheeting. The plastics material may be, or include, CMC.

Broadly, the plastics material can be any plastics material capable of extrusion or other process to result in a sheet form, and the density of the material used can depend on the intended application.

The plastics material can include further additives such as, but not limited to, one or more of material related to anti-counterfeiting, antimicrobials/bio-stabilisers, antioxidants, antistatic agents, biodegradable plasticisers, degradable plasticisers, blowing agents, external lubricants, fillers/extenders, flame retardant, fragrances, heat stabilisers, impact modifiers, internal lubricants, light stabilisers, pigments, plasticisers, process aids and reinforcements.

The recesses may be filled or partially filled with a further material, such as one of the plastic materials referred to herein, or another material. The filling may be by any means, including cascade filing, waterfall filling, dipping or emersion filling, injection filling or the like.

The channels may also be partitioned or sealed by an intervening post member on the upper side of the interposed sheet between adjacent recesses. The post member may be configured to partition, bridge or separate the channels.

Edges of the sheeting may be crimped or sealed to prevent ingress to the channels or recesses.

The interposed sheet may be arranged in at least one layer, or at least two layers.

In a further aspect, there is provided a method of manufacturing packaging sheeting, the method including:
thermoforming multiple either regular or inherently irregular polygon-shaped recesses in a symmetrical repeat pattern on a sheet of material;
extruding a molten material to form an upper outer wall and a lower outer wall;
interposing the thermoformed sheet between the upper outer wall and the lower outer wall; and
fixing the interposed sheet to the upper outer wall and the lower outer wall.

The thermoforming of multiple either regular or inherently irregular polygon-shaped recesses, or flutes, may also form interconnected channels between the recesses on an upper side of the interposed sheet.

The interposed sheet may be fixed to the upper and lower outer walls by lamination.

The method may include filling or partially filling the recesses with a further material, and the filling may be effected before, or during fixing of the upper and lower outer walls to the interposed sheet.

The method may further include filling or partially filling the channels on the upper side of the interposed sheet.

The method may include sealing the edges of the sheeting. The sealing may be by crimping, laminating, gluing, or any other practicable means.

The method of the invention may include at least a second interposed sheet fixed between a first interposed sheet and the upper or lower outer wall. The, or each interposed sheet may also be fixed to an intermediate wall between the interposed sheets.

The features described in relation to one or more aspects of the invention are to be understood as applicable to other aspects of the invention. More generally, combinations of the steps in the method of the invention and/or the features of the product of the invention described elsewhere in this specification, including in the claims, are to be understood as falling within the scope of the disclosure of this specification.

Persons skilled in the art will appreciate that many variations may be made to the invention without departing from the scope of the invention, which is determined from the broadest scope and claims.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a flow chart of a method of forming a packaging lamination according to one aspect of the invention;

FIG. 2 shows a flow chart of the material process steps of method of forming a packaging lamination of the sheeting of FIG. 1;

FIG. 3 shows a diagrammatic view of the input of various materials for mixing and extrusion into a recyclable layer or sublayer according to one aspect of the invention;

FIG. 4 shows a diagrammatic view of the calendering of the recyclable layer of FIG. 3;

FIG. 5 shows a diagrammatic view of the combining of a multi-layer sheeting with LDPE resin as the intermediate liquid laminating material according to one aspect of the invention;

FIG. 6 shows a diagrammatic view of corrugation and fixing of an upper layer, a lower layer and an interposed flute, to form a sheeting according to one aspect of the invention;

FIG. 7 diagrammatic view of corrugation and fixing of an upper layer, a lower metallised layer and an interposed fluted layer, and then adhering of a layer closed cell foam to form a sheeting according to a further aspect of the invention;

FIG. 8 is a diagrammatic view of a fluted layer including hexagonal shaped cells with channels therebetween forming a matrix fluting as one example of a fluting including polygonal shaped cells;

FIG. 9 is a diagrammatic cross sectional views of three examples of laterally consistent profile fluting, each example having a different liner wall angle, wavelength and height; and

FIG. 10 is a diagrammatic view of a control system of the stretch variation of the sheeting by control of the speed ratios, including of the base sublayer of sheeting and printable sublayer.

FIG. 11 shows a flow chart of a method of forming a sheeting layer according to one aspect of the invention. The dashed boxes represent optional steps in the method.

### DETAILED DESCRIPTION OF SPECIFIC EMBODIMENTS

It should be noted in the following description that like or the same reference numerals in different embodiments denote the same or similar features.

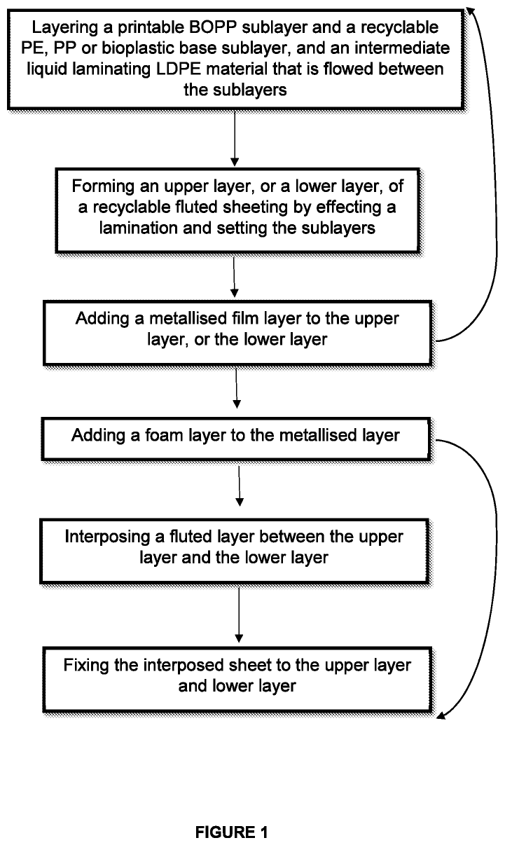

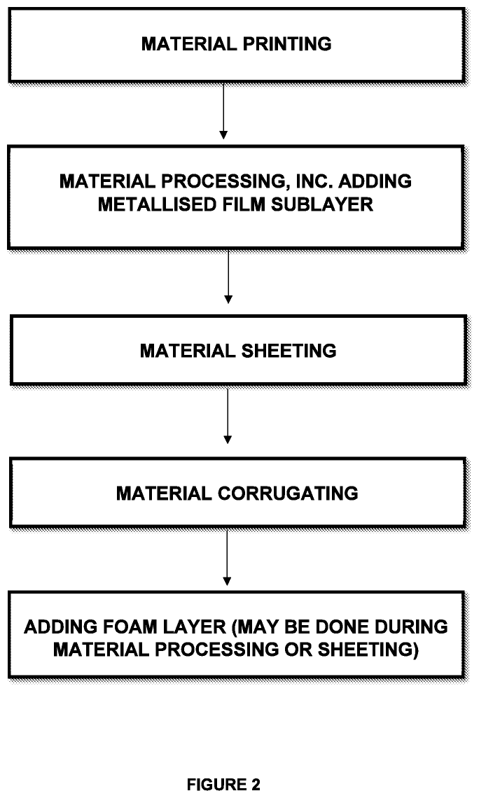

Referring to FIG. 1 there is shown a method of forming a fluted sheeting, the method comprising the steps of: a) Layering a printable BOPP sublayer and a recyclable PE, PP or bioplastic base sublayer, and an intermediate liquid laminating LDPE material that is flowed between the sublayers b) Forming an upper layer, or a lower layer, of a recyclable fluted sheeting by effecting a lamination and setting the sublayers; c) Adding a metallised film layer to the upper layer, or the lower layer; d) Adding a foam layer to the metallised layer; e) Interposing a fluted 20) layer between the upper layer and the lower layer; f) Fixing the interposed sheet to the upper layer and lower layer

Step c) may be performed before step a), where the printable BOPP sublayer is coated with the metallised film sublayer prior to layering with the plastic base sublayer and LDPE.

Step d) may be performed after step f), wherein the foam layer is added after fixing and corrugation.

### Recyclable Base Sublayer

The base sublayer is formed from 40%-80% calcium carbonate (limestone) and 20%-60% high density polyethylene (HDPE). The limestone is extracted from existing limestone quarries and processed into a fine powder. The HDPE is commonly manufactured from non-renewable oil and gas, but renewable alternatives including plastics made from sugar cane or wholly recycled HDPE known as rHDPE, are increasingly available.

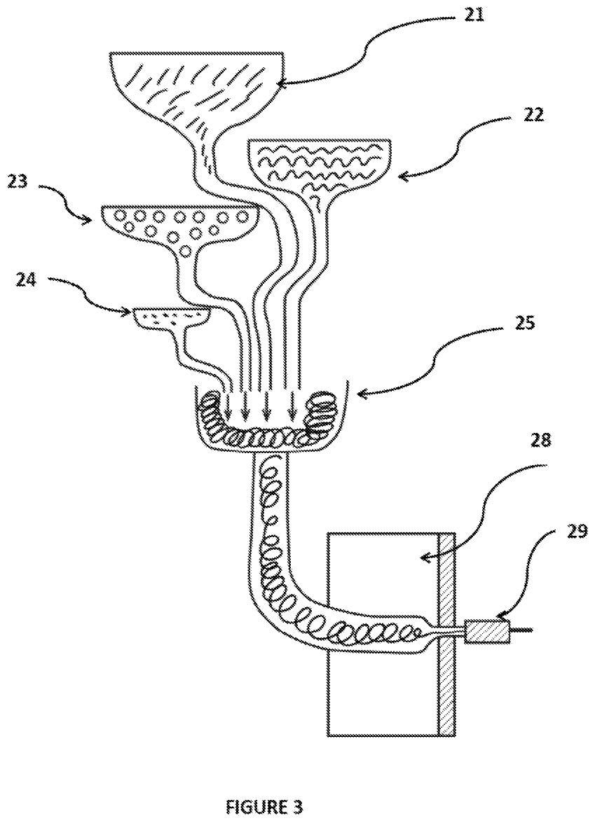

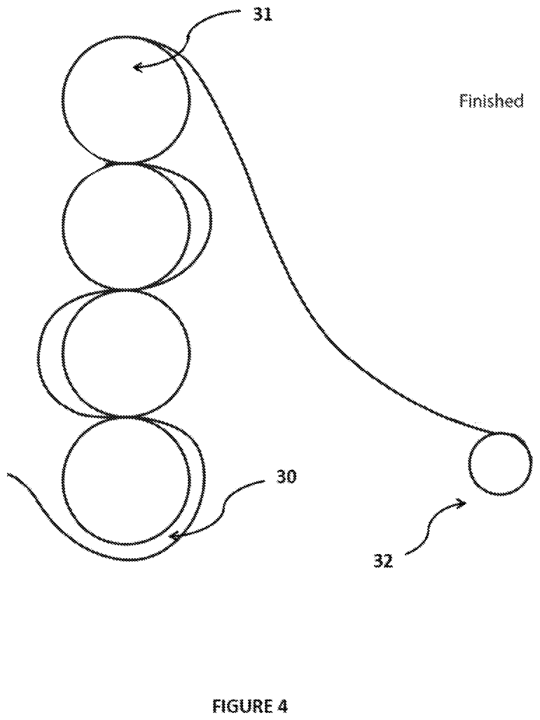

As shown in FIG. 3 the various materials (e.g. HDPE, calcium carbonate) are introduced into vessels 21, 22, 23 24 and mixed under heat in vessel 25. The material is extruded in die vessel 28 and out extrusion nozzle 29 and as per FIG. 4 calendered 30 to required thickness and density using calender rollers 31 to produce a continuous roll 32.

A weight of the calendered material can be about 100 gsm to about 750 gsm, depending on the application. Other thickness materials can be used in packaging sheeting according to the invention. The weight of the material used for the walls 12, 14 and interposed sheet 16 can be from about 100 gsm to about 1000 gsm.

### Printed Sublayer

The print is undertaken on very thin low micron BOPP film. BOPP is an acronym for Biaxially-Oriented (BO) Polypropylene (PP); biaxially refers to the film being stretched in both machine and transverse directions, producing molecular chain orientation in two directions. This inherently gives the film good X and Y axis strength.

The BOPP film may be between about 15 microns and 50 microns in thickness.

This layer of BOPP film can be flexographically or Gravure printed and sealed to give the desired print effect both before and after lamination.

### Fluting

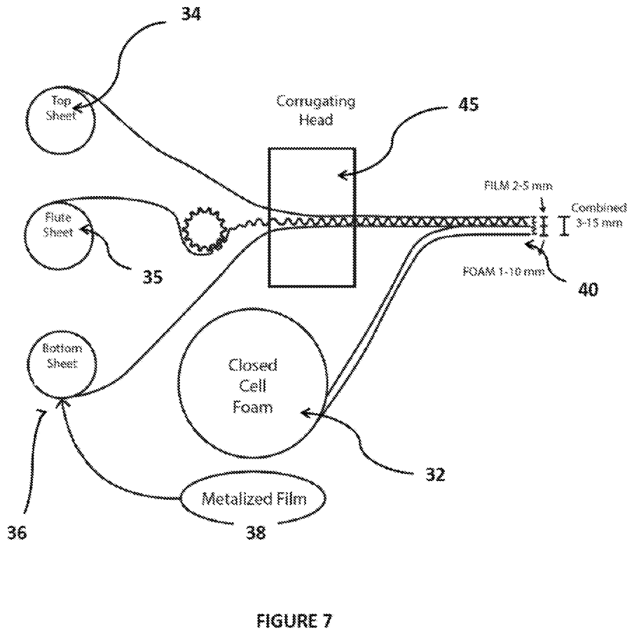

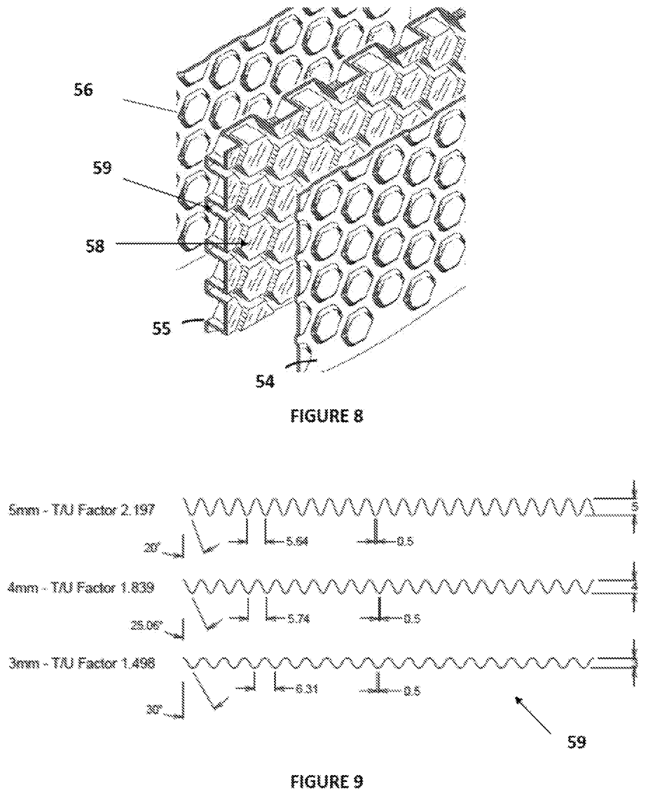

The use of fluting provides air gaps that assist thermal qualities. As shown in FIGS. 7 and 8, this can be by honeycomb or polygon profile 55 with spacing channels 57 in between, or circular flute recesses, or by standard laterally extending flute profiles 59 with consistent cross-sectional profile.

The corrugating process incorporates heat lamination as well as resin lamination which increases the speed of production and increases the strength of the lamination and maintains the recyclability. Immediately after the flute has been formed using the heated flute rollers and before the flute comes in contact with the top and bottom sheet, a resin is applied to the bottom sheet and the top of the flute and as the sheets then come together to form a combined sheet with the resin bonds the tips of the flute to the top and bottom sheets forming a more rigid board and running at speed of up to five times or more existing processing.

Where the fluting comprises a honeycomb profile, or other polygon or circular flute profile, the fluted sheeting may include liquid or foam resins that are cascade or waterfall filled into the open cells. The filling provides additional unique properties to the sheeting, such as improved strength or thermal/insulating properties. It will be apparent that the filling of further material, which may be resins, is undertaken between the fluting being produced and the top sheet being fixed to the fluted sheet.

Wave shape flute profiles, having a consistent cross-sectional profile, may also be used. Such fluting, in some applications within the scope of the present invention, can have a plurality of ribs in which consecutive pairs of ribs converge towards each other between the upper wall and the lower wall to alternately oriented apices at each convergence; a bridge of between 0.5 mm and 0.8 mm is formed by contact of each apex with the wall, each bridge being substantially parallel to the wall; and each pair of consecutive apices are between about 5 mm and about 7 mm apart, and the upper wall and the lower wall are about 1 mm or more apart. In particular, the profile 35 may effectively be that shown in FIG. 8 where there is differing heights of 3, 4, or 5 millimetres with differing wavelength in the range of 5.64 to 6.31 mm which gives a varying linear wall angle of 20° to 30° on the substantially sinusoidal cross section but which can be more a linear sinusoidal shape. The fluting may at least two such fluted plastic members interposed between the upper and lower walls. Further features and alternative fluted sheeting arrangements may be used, including those set out in Australian patent application no. 2018333269 entitled “Fluted Sheeting” filed on 14 Sep. 2018

### Resin

The LDPE resin can be of the type polymer-E with the following characteristics: appearance: translucent white solid pellets; auto-ignition temperate of 349 degrees Celsius; Density between 0.915 and 0.926 g/cm³; odor: negligible; melting point/melting range: 100 to 111 degrees Celsius; Flash Point: about 340 degrees Celsius (Close Cup method); not soluble in water.

### Lamination

Before any layers are corrugated together (i.e. to form the fluted sheeting comprising a lower layer, fluted layer and top layer), there is a laminating process that may be performed on the same site as the corrugation, where the a printed sublayer is run and laminated to a base sublayer to form the upper layer of the fluted sheeting. This lamination process is applied to assist the layering of the two sublayer materials (i.e. a printed PP plastic and a PE based plastic, or bioplastic) which may not cleanly, easily or naturally bond using heat or many other resins.

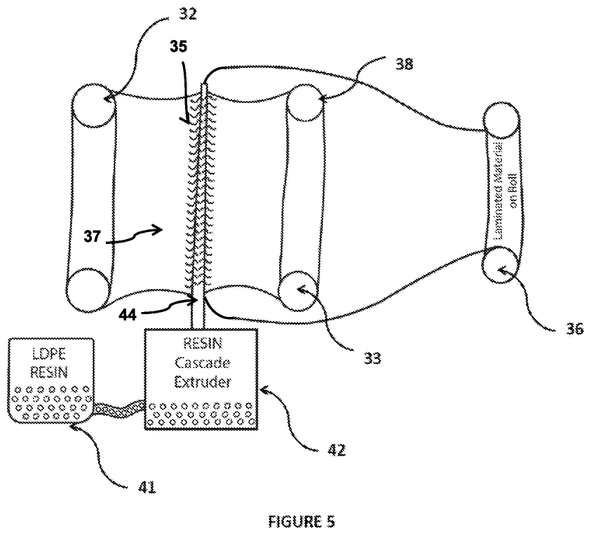

Referring to the drawings there is shown in FIG. 5 that if lamination is required, a base HDPE sublayer 37 is fed from a roll 32 (e.g. produced by the extrusion and calendaring described 20) above) towards the cascade resin screw 44, and a printed BOPP sublayer 38 is fed from a roll 33 towards the cascade resin screw 44 which applies liquid LDPE resin 35 as the bonding agent between the two sublayers 37, 38. The melted resin is screwed through the extruder along the length of the screw arm 44 where it is released in a cascade waterfall process. The BOPP sublayer 38 and the HDPE sublayer 37 may travel over heated rollers to pre-heat the material to a temperature closer to the processing temperature of the (molten) liquid LDPE 35 to assist with 25 the lamination.

In particular, BOPP and HDPE (or other materials, such as some PP or PE based plastics, and a foam) will not readily bond together. However, when a thin waterfall of LDPE resin is melted and cascaded between the two sublayers as they come together this forms a strong bond between the sublayers, making them very difficult to separate.

In essence the two materials of BOPP and HDPE will not bond directly together. However, when a thin waterfall of LDPE resin is melted and cascaded between the two sheets as they come together this forms a bond that is virtually inseparable.

The resulting printed BOPP/LDPE/HDPE laminated sheet 36 may be used as a recyclable top wall (also referred to as an upper layer) of the fluted packaging according to one aspect of the invention.

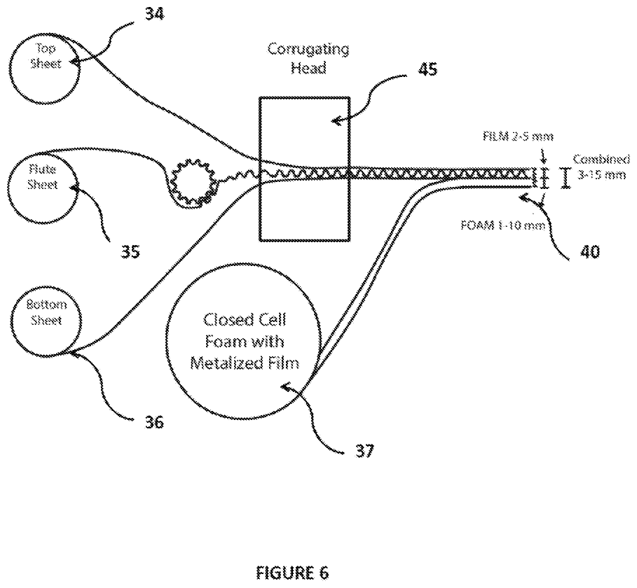

Once the sublayers are combined together, they are left for at least 24 hours (sometimes much longer, depending on manufacturing schedules) to allow the LDPE resin to cure and harden to effect the lamination, before the upper layer put on the corrugator 45 (see FIGS. 6 and 7) to be combined with the fluted layer 35 and lower layer 36.

Other plastic materials may be used for the printed sublayer, including straight polyethylene or cast polypropylene (CPP). Printed PE film can be directly laminated to base sublayer without the need for LDPE bonding agent due to the synergies between HDPE and PE (and like materials). However, the print quality can be reduced or substantially reduced on such materials, as compared to the quality of the gravure print on BOPP.

Critical to the manufacturing process including an externally printed material in fluted sheeting is that the laminating needs to be done in a way that does not distort or stretch the print to any considerable diminishing of the print quality. This needs to be considered at every step of the process, including when the printed sublayer is directly layered to adjacent sublayers (e.g. in the process the subject of the invention, during LDPE lamination to the base sublayer), and where a printed laminated layer (e.g. the upper layer) is fixed to adjacent layers (e.g. the fluted layer) during corrugation or fixing of the layers. In addition, this process needs to ensure there is no ink transfer through the heating used to corrugate or fix the upper sheets (also referred to as upper layers) to the fluted sheet (also fluted layer) and the lower sheets (also referred to as lower layers).

A further critical feature of the manufacturing process for the fluted sheeting and the fluted sheeting product the subject of the invention, is that it applies manufacturing processes and incorporates materials in such a manner to maintain the high recyclability rate of the fluted sheeting, as well as creating a cross directional strength in sheeting including at least one resilient laminated layer. It is noted that the laminated BOPP/LDPE/HDPE layer (or other suitable combination as described herein) can also be used as the lower layer in the fluted sheeting (e.g. so the lower layer and upper layer have the same structure, incorporate the same materials and exhibit the same qualities). Besides providing a benefit of a sheeting with a high quality printed layer on both sides (i.e. printed surfaces on both the upper/top and lower/bottom sides), this incorporates and amplifies the thermal barrier, moisture barrier and strength qualities of the material on both sides (i.e. on both the upper/top and lower/bottom sides) and so the overall fluted sheeting product. This further facilitates direct food contact post recycling.

A printed sublayer laminated to base sublayer may provide a between 10%-20% increased puncture resistance/burst and rigidity in the combined layers. Also, by printing on both the inside and the outside layers (also referred to as the upper and lower layers, walls or liners) of the fluted sheeting using the same manufacturing process, and corrugating the fluted layer together with those layers, both print surfaces are able to be applied to the flute in a single pass.

The BOPP material thickness can be in a range between about 10 microns and about 50 microns, and the BOPP/LDPE/HDPE layer (or similar layer, as described herein), can have a thickness in a range of between about 50 microns to about 1000 microns.

In FIG. 8, there is shown a first embodiment of packaging sheeting viewed in an exploded perspective view, indicating an upper layer (outer wall) 54, the lower layer (inner wall) 56, and the fluted layer (interposed sheet) 55. The either regular or inherently irregular polygon-shaped recesses 58, in this embodiment hexagon-shaped recesses, can be any practicable uniform size, for example, each recess can have an edge length 20 of from 1 mm to 10 mm, and a height 22 of from 0.5 mm to 6 mm. The distance between adjacent hexagon-shaped recesses can be from 0.5 mm to 6 mm.

The recesses of the fluted layer (interposed sheet) 58 can be formed by any practicable method. The material of the fluted layer (sheet) is plastic, so recesses can be formed by extrusion, vacuum forming and/or thermoforming. The walls 54, 56 can be any thickness, including from about 100 μm to about 750 μm.

The upper outer wall 54 can be fixed to the top hexagonal face 58 of each recess 59 of the interposed sheet 55. The lower outer wall 56 is able to be fixed to the bottom ledge of each interconnecting wall of each recess 59. In this way, the interposed sheet 55 is ‘sandwiched’ between the upper wall 54 and the lower wall 56, to give sheeting of from about 0.5 mm to about 10 mm thick. In particular embodiments, the thickness is between about 1.5 mm and about 4 mm.

Interconnected channels 59 are formed on the upper side 55 of the interposed sheet, between the recesses, and defined by the outer edges of the interconnecting walls. The channels can be filled or partially filled with material that can increase a desired property of the sheeting, for example strength, resilience, water resistance, pliability and the like. The material can be any practicable material (e.g. a foam, gel or resin) and can be introduced into the channels 59 at any time before, during or after fixing of the interposed sheet 55 to the upper wall 54 and lower wall 56.

The edges of the fluted sheeting can be sealed or partially sealed to prevent ingress of unwanted materials, for example water, dust, contaminants, microorganisms and the like. Sealing can be by any practicable method, such as crimping (e.g. heat crimping), gluing, clamping, and laminating.

The fluted sheeting incorporating the symmetrical array of polygon-shaped or circular-shaped recesses/channels as described herein, can provide sheeting with strength of about 30% greater than that provided by fluting in conventional cylindrically fluted sheeting in similar materials. The fluted sheets 55, for example, may include the either the regular or inherently irregular polygon-shaped recesses (e.g. square-shaped, triangle-shaped, or hexagon-shaped recesses). The orientation and configuration of the recesses of the fluted sheet 55 of sheeting imparts an enhanced resistance to crushing to the sheeting.

This increased strength can be indicated by the take-up factors of the sheeting of the invention: Take-up factor, or take-up ratio, is a measure of the amount of plastic material required for sheeting to provide a specified strength. Take-up factor is calculated by dividing the length of a fluted sheet by the length of plastic sheet required for the fluted member, for a given strength of sheeting. Alternatively stated, the fluted sheeting described herein, and that disclosed in PCT/AU2021/050075 entitled “Packaging sheeting and a method of manufacturing packaging sheeting” filed on 1 Feb. 2021, requires substantially less plastic material for the interposed sheet than conventional fluted sheeting, to provide comparable strength. It follows that the greater the take-up factor, the more material has been used to manufacture the sheeting. Generally speaking, this would be expected to proportionately increase the strength of the sheeting. The sheeting according to the invention can show increased strength at lower take-up factors than conventional sheeting.

In the examples described above, the upper and lower layers, fluted sheets or the sublayers, can be extruded, calendered, or otherwise manufactured (e.g. by lamination), separately and subsequently fastened together in a lamination or corrugation process. Depending on the size requirements, any number and configuration of the layers of the sheeting of a predetermined width can be manufactured independently, then combined to form the fluted sheeting of the present invention.

The weight of the material used for the base sublayer (e.g. HDPE sublayer) can be from about 100 gsm to about 1000 gsm, depending on the application. The weight of the material used for the fluted layer (or fluted sheet, interposed sheet) 55 can be from about 100 gsm to about 1000 gsm, depending on the application. Other weight and thickness of materials can be used in sheeting according to the invention, and it higher weights do not necessarily translate to greater thickness as thickness may depend on the density the film, the way in which it is manufactured and how compact the resins are within the sheet.

Instead of including discrete sublayers that are joined or fixed together, the fluted layer and one or the upper or lower layers (or outer walls) may be in the form of a unitary, one-piece structure. Such a structure can be the result of an extrusion process, for example, or some other process capable of producing such a structure.

Furthermore, the sheeting can have two, three or more layers of the fluted sheet, depending on requirements.

It will be appreciated that the various parameters described herein can be varied depending on the desired application for the sheeting, within the scope of the invention. Thus, the sheeting embodiments are not limited to spacing, layer thickness, type of plastics material, weight (for example, in grams per square metre) of the plastics material, or method of production, unless such qualities, materials or methods are identified as essential.

The sheeting can have multiple applications and is not limited to any single application. For example, the sheeting can be used for packaging and construction applications where the inherent resistance to moisture damage of the plastics material is useful. Such applications can also be those in which the inherent resistance to damage by insects of the plastics material is useful, or for thermally insulating or surface protection applications (e.g. in construction).

### Metallised Sublayer (or Metallised Film)

The metallised film is aluminium, but may be nickel, chromium (e.g. to provide a shiny metallic appearance, desirable in some printing applications). It can be used to coat an OPP (oriented polypropylene) film. The metallised film is applied applies to the plastic sublayer by vacuum coating, or other suitable coating processes. It is a very thin layer, usually less than 1% of the total of the plastic OPP sublayer.

The metallised film layered with PP can be a MC102 High Bond Metallised Cast PP film. The PP can be BOPP.

The metallised film on plastic sublayer has the main features of: a) thickness of between 15 micron or 50 micron; b) coating uniformity; c) heat seal performance; d) high Al adhesion strength (e.g. MC102/105); and e) provides an effective WVTR & Light Barrier (for example, MC102/105>200 g/25 mm)

Table 1 below indicates properties a preferred metallised (Al) film being a MC102 High Bond Metallised Cast PP film. The following abbreviations have been applied in Table 1: UT—Untreated Side; T—Treated Side; NB—Normal Bond; HB—High Bond; SD-Standard OD; #—Subject to storage condition; MD—Machine Direction; TD—Transverse Direction.

TABLE 1

| Properties | | Test Method | Unit | Typical Value/Specification | | | | |
|---|---|---|---|---|---|---|---|---|
| THICKNESS | | ASTM D1777 | Micron | 20 | 25 | 30 | 35 | 40 |
| | | | Gauge | 80 | 100 | 120 | 140 | 160 |
| | | | Tolerance | +/−3% | | | | |
| Al Coating Thickness, OD | | In House, X-Rite | OD | 2.30 ± 5% | | | | |
| DENSITY | | In House | g/cm³ | 0.910 | 0.910 | 0.910 | 0.910 | 0.910 |
| GRAMMAGE | | Internal | g/m² | 18.2 | 22.8 | 27.3 | 31.9 | 36.4 |
| YEILD | | Internal | m²/kg | 54.9 | 44.0 | 36.6 | 31.4 | 27.5 |
| COF, heat seal side, Kinetic | | ASTM D-1894 | — | 0.4-0.7 | | | | |
| TENSILE STRENGTH | MD | ASTM D-882 | N/mm² | 35-90 | | | | |
| | TD | | | 20-60 | | | | |
| ELONGATION AT BREAK | MD | ASTM D-882 | % | 400-900 | | | | |
| | TD | | | 600-1150 | | | | |
| MODULUS OF ELASTICITY | MD | ASTM D-882 | N/mm² | 300-800 | | | | |
| | TD | | | 300-800 | | | | |
| THERMAL SHRINKAGE | MD | ASTM D-2732 | % | 0 to −1.0 | | | | |
| (120° C., 2 min) | TD | | | 0 to +1.0 | | | | |
| HEAT SEAL INITIAL TEMPERATURE | | ASTM D-F2029 | ° C. | 113 | | | | |
| (UT/UT, >5N/15 mm) | | 1 bar, 1 s (back-tape) | | | | | | |
| HEAT SEAL STRENGTH | MC101/102 | | N/15 mm | 8 | 10 | 11 | 12 | 13 |
| at 120° C. | MC105 | | | 10 | 12 | 13 | 14 | 15 |
| HEAT SEAL RANGE | MC101/102 | | ° C. | 115-135 | | | | |
| | MC105 | | | 115-145 | | | | |
| AL ADHESION | NB-MC101 | AIMCAL TEST TP-105-92 | g/25 mm | >50 | | | | |
| STRENGTH, AL SIDE | NB-MC102/105 | (EAA 75/100 μM) | | ≥200 | | | | |
| WVTR(Water Vapor | SD | ASTM F-1249 | g/m2/24 hr | ≤0.8 | | | | |
| Transmission Rate) | | | | | | | | |
| 38° C. & 90% RH | | | | | | | | |
| OTR (Oxygen | SD | ASTM D-3985 | cc/(m2/24 hr) | ≤80 | | | | |
| Transmission Rate | | | | | | | | |
| 23° C. & 0% RH | | | | | | | | |

| | | | |
|---|---|---|---|
| Surface Tension, Al side # | D-2578 | dyne/cm | 36 |

### Examples

### a) For Laminating the Printable Sheet Sublayer to the Base Sublayer

Low Density Polyethylene is used a heat sealing substrate. The melting point is in a range between about 110 degrees C. to about 115 degrees C., and the processing temperature is in a range between about 150 degrees C. and about 210 degrees C.

The temperature range in which the LDPE is initially heated for laminating is 310 to 320 degrees in the extruder 42, which is a range that is suitable to eliminate bubbles and increase smooth running for the bonding of the sublayers.

In the process of lamination, LDPE is heated at a temperature in a range between about 310 degrees Celsius and about 320 degrees Celsius, since at this temperature the LDPE melts well for enough flowability in the extrusion well (sufficient flow and thickness for curtain coating film).

The LDPE laminator speed is operated at a speed in a range between about 35 m per minute to about 120 m per minute. This speed can be configured to substantially match the extrusion machine (e.g. for the HDPE composite base layer) and keep those manufacturing processes coordinated. This speed allows for the even spread of the LDPE as well as complete (100%), or near complete, contact adhesion when this speed is combined with a 200 degree Celsius resin temperature at time of contact and an about 310 degree Celsius to about 320 degree Celsius melted temperature within the process.

Bubbles spots in the lamination can be avoided by using the correct combination of LDPE temperature (or temperature ranges) and lamination speed. Significant bubbles and spots may be caused by moisture getting into the LDPE resin 41, and after heating in the extruding machine 42 there may be bubbles in the curtain coating process which can only be seen after the laminate process is completed which is then too late. Therefore, the LDPE is pre-heated in machine 41 to a stable temperature in a range of about 70 to about 90 degree Celsius for more than thirty minutes to eliminate any moisture and eliminating the risk during production, and before pushing the resin to extruder 42 to achieve a higher temperature prior to cascade flowing via the screw arm 44. Temperature of the heated LDPE is lost during movement through the screw and during the process of cascade waterfall application of the liquid LDPE, requiring careful management of the temperature to achieve optimal lamination.

### b) Controlling the Printed Laminated Layer Relative to a Fluted Layer or Lower Layer

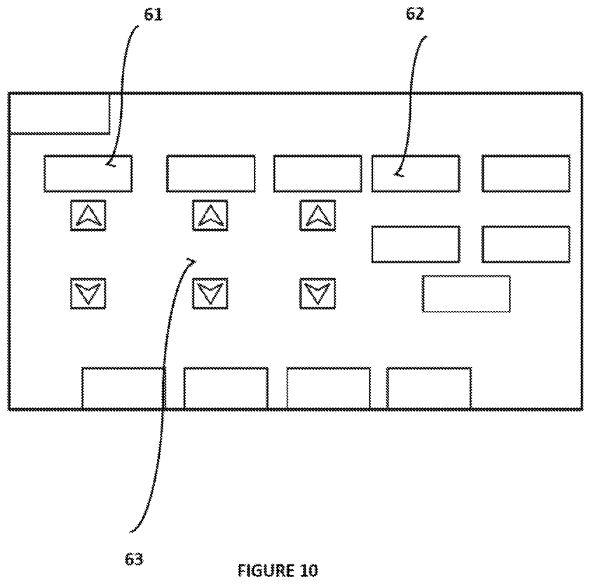

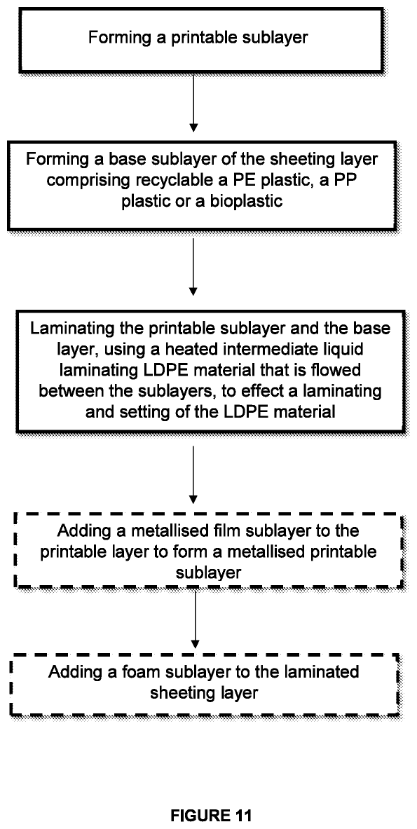

Referring to FIG. 10, it is noted that the BOPP layer may be printed with a shortened/shrunk printed dimension compared to the final packaging dimension, as it expands during layering of the final sheeting. The stretch variation in BOPP is able to be managed by the speed ratio between the printed laminated BOPP/LDPE/HDPE layer relative to the fluted layer and the lower layer. The main machine is corrugator machine, and auxiliary machine is the forming machine and the cooling machine. A relatively higher speed is chosen auxiliary machine 2, and a relatively lower speed for auxiliary machine 1, and the lowest speed for the corrugating machine to assure there have enough heat and tension to avoid the board crushing. The tension force controls the stretch for the printed laminated layer in the process of cooling and forming the board. The ratio is 1.06 to 1.2, in all directions, based on the actual material, temperature and situation of the run. The goal is to keep the roll pressure and release with a steady stretching force. If the stretch force changes quickly this can cause the laminating stretch and shrinkage problem. The pressure is therefore maintained at a steady level and at a relative status to the HDPE sheet using the special auto tensioning machine.

A 1.06 stretch rate may be applied. In other words, the length of cutting board compared with the length of print pattern (base on the same position line) is 1.06. This rate is applied now, to meet current performance requirements, the rate being based on the final dimension of the cutting board to design the print pattern (e.g. its width and length). This dimension is the specification of the BOPP print pattern, and the machine operator sets the parameter of the machine to ensure the final dimensions meet the required specification.

### c) Corona Treatment

In order to avoid the transfer of the ink either to another surface or simply rubbing off on other surfaces we need to corona treat all materials. The corona treatment is the process of putting an electrostatic charge through the material which causes a sticky type arrangement when the ink and the BOPP comes in contact with it. The BOPP also has a corona treatment applied to it, meaning both surfaces have a stickiness to them.

The purpose of corona treatment increases the surface energy and roughness of the films, to improve wettability and adhesion of inks, coatings and adhesives. Treating works best when a substrate is treated at the time of extrusion and in-line prior to converting. This can be done to produce enough roughness that makes the ink and other materials bond. With the BOPP film it has strong bond strength which can after corona treatment and lamination then sustain normal peel test. A dyne pen can be used to measure this roughness after the corona treatment. The DOE is performed to find the right value of dyne (roughness) and right parameter of corona process (e.g. power and time).

d) For the Corrugating Process when Only the Outside Print Sheet is Applied

The temperature that the corrugator is run at is different in scenarios where there is a printed layer, compared to when there is no printed layer. When running a printed material, a temperature of about 140 degrees Celsius on the corrugator is used, and about 135 degrees Celsius for plain material (not printed). For the top layer in the process of corrugating, all film must be melted in order to attach well to the flute, and with the addition of a printed lamination sublayer, more energy/heat is required to get an equivalent bond/melt temperature. Therefore, the flute and lower layer (if not printed) have no temperature change relative to the upper layer to ensure the print has no effect on the middle and bottom film, and the temperature across all layers is adjusted based on the layer thickness and run speed.

To avoid stretching or shrinkage of the printed layer with the heat associated with corrugating, an auto-release device is able to control stretch force for all rolls release feed to the corrugator machine, and the speed rate of the cooling machine/system and the corrugator machine are adjusted to keep steady the stretch force obtained on the machine and collected at each process. Generally speaking, a stretch force of 1:1.1 to each of the three layers with their speed rate is applied, and this can be adjusted based on the final production dimension measurement for the corrugation process uniformly during production. This process is unique to each and every print/material combination.

To manage registration for the printed layer with the cutting knife at the end of the line dictating the cut length of the sheet to registration, including managing a shift in material of up to +/−3-7 mm, a high precision rotary cutting/flat bed die cutting tool for the finish cut sheet size is used in order to get the accurate print dimension outcome.

d) For the Corrugating Process when Both the Upper Layer and the Lower are Printed (i.e. when Both Sides of the Fluted Sheeting have a Printed Sublayer)

The temperature at which the corrugator is run is different to when only corrugating with one printed layer, or when there is no printed layer (i.e. running plain material), in the manner as described above.

The processes around avoiding the stretch or shrinkage with the heat when corrugating when laminating BOPP to the upper layer (sheet) and the lower layer (sheet), is the same as that described above.

The challenges with registration for the printed upper layer (e.g. outer sheet of a box) when also laminating BOPP to the lower layer (e.g. inside sheet of a box) is the same as that described above.

### e) Other Features of the Product or Manufacturing Method

Usefully, the extrusion of the base layer may occur on the same site together with the machinery for LDPE lamination and corrugating and fixing together the upper and lower sheets with the fluted layer.

Particular ranges for the described thickness of the metallised layer and the closed cell foam have been resolved by unexpected experimental research. It was discovered that layers thicker than the preferred ranges provided for the metallised film and closed cell foam did not produce any benefit to the recorded thermal properties of the material, and in some cases thicker material produced a less effective thermal barrier.

Again, there is an advantage in manufacturing since the closed cell PE foam can be added to the lower wall (layer) in line with the corrugating, and in particular the heating of the lower layer during corrugation provides an ideal temperature to permit heat lamination of the upper surface of the PE foam to the lower layer of the corrugated sheet, thereby creating a synergistic efficiency in sheeting manufacture.

It can be seen that one or more of the following benefits may be delivered by the proposed invention: improvements in the printing quality of recyclable sheeting; suitability of the sheeting to be used in moist environments such as in refrigeration or with ice packing; manufacturing process that does not negatively affect quality of print and smoothness of the look of printed sheeting; packaging which is able to knocked down easily; sheeting and packaging which is able to be washed and sanitised; able to be reused multiple times following washing and sanitizing; (regarding the sheeting including the printed sublayer and the base sublayer); use of a plastic in lower quantities and together with the natural product of calcium carbonate that has zero carbon energy rating and therefore a significant benefit of being environmentally friendly; an in-line and high speed manufacturing process for sheeting; a recyclable alternative to EPS; a sheeting having high thermal barrier and moisture barrier properties; recyclable sheeting being particularly suited to box packaging, and an alternative to EPS or other products used in the commercial transportation of food (and in particular, cold chain transport), pharmaceuticals and home delivery.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that each unit between two particular units are also disclosed. For example, if 10 and 15 are disclosed, then 11, 12, 13, and 14 are also disclosed.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Where the term “layer” is used, is may also refer to a sublayer (i.e. one layer within a plurality of layers), and vice versa.

The terms “a” and “an” mean “one or more”, unless expressly specified otherwise

Neither the title nor any abstract of the present application should be taken as limiting in any way the scope of the claimed invention.

Where the preamble of a claim recites a purpose, benefit or possible use of the claimed invention, it does not limit the claimed invention to having only that purpose, benefit or possible use.

In the present specification, terms such as “part”, “component”, “means”, “section”, or “segment” may refer to singular or plural items and are terms intended to refer to a set of properties, functions or characteristics performed by one or more items having one or more parts. It is envisaged that where a “part”, “component”, “means”, “section”, “segment”, or similar term is described as consisting of a single item, then a functionally equivalent object consisting of multiple items is considered to fall within the scope of the term; and similarly, where a “part”, “component”, “means”, “section”, “segment”, or similar term is described as consisting of multiple items, a functionally equivalent object consisting of a single item is considered to fall within the scope of the term. The intended interpretation of such terms described in this paragraph should apply unless the contrary is expressly stated or the context requires otherwise.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used.

Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the fluted sheeting, and more particularly the box and container industries, including commercial food packaging.

1. Fluted sheeting, including:
an upper recyclable plastic layer;
a lower recyclable plastic layer;
a recyclable fluted plastic layer, interposed between the upper and lower recyclable plastic layers;
at least one of the upper or lower recyclable plastic layers comprising:
a printable BOPP sublayer
a base sublayer comprising a PE plastic, or a bioplastic/compostable plastic, a or PP plastic and
the fluted plastic layer comprises a PE plastic, or a bioplastic/compostable plastic, a or PP plastic
wherein
the printable BOPP sublayer is layered to the base sublayer with an intermediate liquid laminating LDPE material;
at least one of the upper or lower recyclable plastic layers includes a metallised film sublayer, the metallised BOPP sublayer having a thickness between about 15 microns and about 50 microns; and
the metallised upper or lower layer further includes a closed cell PE foam sublayer, layered to the metallised layer, the foam sublayer having a thickness between about 1 mm to 10 mm.

2. (canceled)

3. The sheeting of claim 1, wherein the base sublayer comprises HDPE and a proportion of calcium carbonate ranging between about 50% and about 70% w/w of the base sublayer.

4. The sheeting of claim 1, wherein the closed cell PE foam has a thickness of between about 3 mm and about 5 mm.

5. The sheeting of claim 1, wherein the sheeting comprises a foldable blank for packaging sheeting, the foldable blank being configured to be die cut.

6. The sheeting of claim 5, wherein the foldable bank is configured to form a box or other packaging with a closeable lid.

7. The sheeting of claim 1, wherein the sheeting provides an effective thermal and moisture barrier.

8. The sheeting of claim 1 wherein the fluted layer comprises multiple regular or inherently irregular polygon-shaped recesses, or circular-shaped recesses, in a symmetrical repeat pattern; wherein the recesses are hexagonal in shape.

9. (canceled)

10. The sheeting of claim 8, wherein the fluted layer comprises channels interconnected between the recesses, and a thermally insulating filler material is included in the recesses and/or channels.

11. (canceled)

12. The sheeting of claim 1, wherein at least one edge of the sheeting is sealed.

13. The sheeting of claim 1, wherein the sheeting includes a further interposed sheet positioned between the upper layer and a further upper layer.

14. The sheeting of claim 1, wherein the sheeting has a thickness in a range between about 1 mm and about 10 mm.

15. (canceled)

16. (canceled)

17. A method of manufacturing a recyclable fluted sheeting, the method comprising the steps of:
a. Layering a printable BOPP sublayer and a recyclable PE, PP or bioplastic base sublayer, and an intermediate liquid laminating LDPE material that is flowed between the sublayers
b. Forming an upper layer, or a lower layer, of the recyclable fluted sheeting by effecting a lamination and setting of the sublayers
c. Adding a metallised sublayer;
d. Forming a recyclable fluted layer;
e. Interposing the fluted layer between the upper layer and the lower layer; and
f. Fixing the interposed sheet to the upper layer and lower layer;
g. Adding a foam layer to the metallised layer, before or after fixing of the interposed sheet to the upper and lower layer;
wherein
the fluted plastic layer comprises a PE plastic, or a bioplastic/compostable plastic, or a PP plastic
at least one of the upper or lower recyclable plastic layers includes a metallised film sublayer, the metallised printable BOPP sublayer having a thickness between about 15 microns and about 50 microns; and
the metallised upper or lower layer further includes a closed cell PE foam sublayer, layered to the metallised sublayer, the foam sublayer having a thickness between about 1 mm to 10 mm.

18. A method according to claim 17, wherein the metallised sublayer is added to the BOPP sublayer before lamination with the base layer; wherein the foam layer is added to the BOPP sublayer after fixing of the interposed sheet to the upper and lower layers.

19. (canceled)

20. A method according to claim 17, wherein the method further comprises the step of forming one or more of the sublayers of the upper recyclable layer and the lower recyclable layer, wherein the forming of the one or more sublayers of the upper recyclable layer and the lower recyclable layer may comprise extruding a molten material.

21. (canceled)

22. (canceled)

23. A method according to claim 17, wherein the LDPE processing temperature is substantially between 150° C. and 210° C.

24. A method according to claim 17, wherein the BOPP sublayer and the base layer are in rolls of sheets and fed into a laminating machine at a speed that matches the supply from the extruding with the speed of the laminating.

25. A method according to claim 17, wherein the base sublayer and the BOPP sublayer are bonded by flowing a waterfall between the two sublayers using a resin cascade extruder, and wherein the speed of lamination is between 35 to 120 metres per minute.

26. (canceled)

27. A method according to claim 17, wherein the foam layer is laminated to the upper or lower metallised layer using heat lamination.

28. A method according to claim 17, wherein the thermoformed fluted layer comprises multiple regular or inherently irregular polygon-shaped recesses, or circular-shaped recesses, in a symmetrical repeat pattern, and the method further comprises the step of including a filler material in the recesses and/or channels, and wherein the filling is by waterfall or cascade filling.

29. (canceled)

30. A method according to claim 17, wherein the fixing of the interposed sheet to the upper layer and lower layer is by heat lamination.
